(19) United States
(12) Patent Application Publication
(10) Pub. No.: US 2024/0166539 A1
(43) Pub. Date: May 23, 2024

(54) METHOD AND DEVICES FOR CLEANING A FLUID CONTAINING MAGNETIC PARTICLES

(71) Applicant: Saudi Arabian Oil Company, Dhahran (SA)

(72) Inventors: Matteo Leoni, Dhahran (SA); Muhammad Imran Ul-haq, Dhahran (SA); Ahmed K. Alasseel, Dhahran (SA); Sohel Shaikh, Dhahran (SA); Jorge J. Delgado, Dhahran (SA); Mosab T. Kheyami, Al Khobar (SA)

(21) Appl. No.: 17/992,375

(22) Filed: Nov. 22, 2022

(51) Int. Cl. C02F 1/48

(52) U.S. Cl. CPC C02F 1/484; C02F 2201/004; C02F 2201/48; C02F 2301/043

(57) ABSTRACT

The present disclosure provides a method for trapping corrosion products in a plant, the method comprising: installing, at the plant where a fluid is being processed, a trap system having one or more magnetic elements, at least one entry port, and at least one exit port; configuring the trap system such that the fluid flows in a prescribed pattern through the trap system; and activating the one or more magnetic elements of the trap system such that the corrosion products in the fluid are retained by the one or more magnetic elements and limited to portions of the plant while the fluid flows from the at least one entry port to the at least one exit port.

### TECHNICAL FIELD

This disclosure generally relates to fluid processing at an industrial facility such as a plant.

### BACKGROUND

Magnetic particles may be carried by a fluid, such as a hydrocarbon fluid. For example, the magnetic particles can include magnetic corrosion products carried by a hydrocarbon fluid, a gas, a vapor, a supercritical fluid, a superfluid or a mixed-phase fluid (e.g. liquid and vapor, liquid and gas).

### SUMMARY

In one aspect, implementations provide a method for trapping corrosion products in a plant, the method including: installing, at the plant where a fluid is being processed, a trap system having one or more magnetic elements, at least one entry port, and at least one exit port; configuring the trap system such that the fluid flows in a prescribed pattern through the trap system; and activating the one or more magnetic elements of the trap system such that the corrosion products in the fluid are retained by the one or more magnetic elements and limited to portions of the plant while the fluid flows from the at least one entry port to the at least one exit port.

Implementations may include one or more of the following features.

Configuring the trap system may include: arranging the magnetic elements that form a partial blockage of the fluid flowing in the trap system. Configuring the trap system may include: configuring the trap system such that the at least one entry port and at least one exit port are sized and shaped for the fluid flowing in the trap system to accelerate between the at least one entry port and at least one exit port. Configuring the trap system may include: configuring the trap system such that the at least one entry port and at least one exit port are sized and shaped for the fluid flowing in the trap system to decelerate between the at least one entry port and at least one exit port.

Configuring the trap system may include: installing at least one bypass channel for the fluid flowing in the trap system. The implementations may further include: configuring the at least one bypass channel such that when the one or more magnetic elements are de-activated, the fluid flows through the at least one bypass channel. The implementations may further include: configuring the at least one bypass channel to include at least one magnetic element for the fluid flowing through the at least one bypass channel, wherein the at least one magnetic element is different from the one or more magnetic elements.

The implementations may further include: configuring a particle collection sub-system such that when the one or more magnetic elements are de-activated, the corrosion products retained by the one or more magnetic elements are extracted from the trap system. The implementations may further include: installing a non-magnetic cover for each of the one or more magnetic elements. The implementations may further include: configuring the one or more magnetic elements as a grid. The implementations may further include: configuring the one or more magnetic elements on an exterior of a portion of the trap system.

In another aspect, implementations provide a trap system for trapping corrosion products in a plant where a fluid is being processed, the trap system including: one or more magnetic elements; at least one entry port; and at least one exit port, wherein the fluid flows in a prescribed pattern through the trap system, and wherein when the one or more magnetic elements are activated, the corrosion products in the fluid are retained by the one or more magnetic elements and limited to portions of the plant while the fluid flows from the at least one entry port to the at least one exit port.

Implementations may include one or more of the following features.

The magnetic elements are configured to form a partial blockage of the fluid flowing in the trap system. The at least one entry port and at least one exit port may be sized and shaped for the fluid flowing in the trap system to accelerate between the at least one entry port and at least one exit port. The at least one entry port and at least one exit port may be sized and shaped for the fluid flowing in the trap system to decelerate between the at least one entry port and at least one exit port.

The trap system may further include: at least one bypass channel for the fluid flowing in the trap system such that when the one or more magnetic elements are de-activated, the fluid flows through the at least one bypass channel. The at least one bypass channel may include: at least one magnetic element for the fluid flowing through the at least one bypass channel, and wherein the at least one magnetic element is different from the one or more magnetic elements.

The trap system may further include: a particle collection sub-system such that when the one or more magnetic elements are de-activated, the corrosion products retained by the one or more magnetic elements are extracted from the trap system. The trap system may further include: a non-magnetic cover for each of the one or more magnetic elements. The one or more magnetic elements may be configured as a grid.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 shows a diagram of examples of a trap system according to some implementations of the present disclosure.

FIG. 2 shows a diagram of an example of a trap system with a flushing sub-system according to some implementations of the present disclosure.

FIG. 3 shows examples of pass-through magnetic traps according to some implementations of the present disclosure.

FIG. 4 shows an example of a trap system with magnetic elements according to some implementations of the present disclosure.

FIG. 5. shows an example of a trap system with a magnetic grid according to some implementations of the present disclosure.

FIGS. 6A-6B show an example of a trap system with magnetizable plates according to some implementations of the present disclosure.

FIG. 7 shows an example of a trap system in which fluid is forced to change direction according to some implementations of the present disclosure.

FIG. 8 shows an example of a trap system in a tapered configuration according to some implementations of the present disclosure.

FIGS. 9A and 9B show examples of a trap system with magnetic elements installed on the side or the bottom according to some implementations of the present disclosure.

FIGS. 10A and 10B show examples of a trap system with magnetic elements installed on the exterior according to some implementations of the present disclosure.

FIGS. 11 and 12 show examples of results of captured iron particulate matter according to some implementations of the present disclosure.

FIG. 13 shows an example of corrosion product attracted by a trap system according to some implementations of the present disclosure.

FIG. 14 shows an example of diffraction pattern of corrosion products captured by a trap system according to some implementations of the present disclosure.

FIGS. 15A and 15B respectively show examples of fresh and skimmed catalysts seen in a trap system according to some implementations of the present disclosure.

FIGS. 16A and 16B respectively show examples of environmental scanning electron microscopy (ESEM) micrograph and corresponding energy dispersive X-ray spectroscopy (EDXS) spectrum for the corrosion products seen in a trap system according to some implementations of the present disclosure.

FIG. 17 shows an example of a flow chart according to an implementation of the present disclosure.

FIG. 18 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosed technology relates to system and method to solve the problem of movement of and contamination by magnetic corrosion/oxidation particles in a fluidic medium (such as hydrocarbon fluid) through the use of one or more magnetic traps. Implementations can control the spreading of corrosion/oxidation products in a plant, a pipeline, or a trunkline. The implementations can also perform general removal of magnetic particles from a hydrocarbon liquid, a gas, a vapor, a supercritical fluid, a superfluid or a mixed-state fluid. In one example, the implementations can solve a problem of increased delta pressure observed across a synthesis reactor.

Metals in elemental form can pass from a zero-oxidation state to one of many oxidation states, both in dry and in wet conditions. Depending on the oxidation conditions on the oxidizing species involved and over time, the oxidation process can lead to the metal ions immersed in a solution of a fluid medium, or transformed into one or more insoluble or partly soluble compounds in the fluid medium. Corrosion, oxidation or scaling are common terms employed to denote these phenomena. The properties of those oxidized compounds can be quite diverse. The oxidized compounds can affect the pipeline system in which the compounds have been formed and/or the system where the compounds are being transported to.

A magnetization, either permanent or induced through an external electromagnetic field, can be observed in some of the oxidization compounds. Common examples may include magnetite (iron oxide), greigite (iron sulfide), pyrrohotite (iron sulfide), pyrite (iron sulfide), mixed ferrites such as e.g. (Ni—Fe)₃O₄, and cobalt oxide. Substitutional ions may also be present in those compounds. Suitable chemicals (corrosion inhibitors) as well as physical methods (e.g. cathodic protection, coating, lining) can be employed to reduce the corrosion/oxidation or mitigate the impact of corrosion/oxidation on a system. When a suitable fluid is present, it is feasible to perform removal and transport of the corrosion/oxidation products from the location where the products are formed. This movement, as well as the accumulation of the compounds (or the alteration products) in certain locations, can cause interruption or disruption of operation processes, changes in surface properties, or alteration of the environment.

Implementations of the present disclosure can solve the problem of movement of and contamination by magnetic corrosion/oxidation particles through the use of a magnetic trap. On conventional systems, magnetic traps have already been proposed for the removal of magnetic particles from a non-hydrocarbon liquid in an open system, or have been installed on pipes or as strainers for pumps, to prevent the open system from getting blocked e.g. by iron particles. Implementations of the present disclosure, however, can operate on a closed pipe/vessel system and control the spreading of corrosion/oxidation products in a plant through the use of magnetic traps. Implementations may also incorporate the application of magnetic trap devices for the general removal of magnetic particles from a hydrocarbon liquid, a gas, a vapor, a supercritical fluid, a superfluid or a mixed-state fluid (e.g. a mixture of liquid and vapor, liquid and solid, liquid and granular medium). Significantly, implementations can limit the spread of the corrosion products in a closed-circuit system. In various implementations, the use of the magnetic trap can extend the operation of a plant by delaying the need for cleaning, scraping. Implementations can achieve such benefit without changing conventional corrosion control measures or existing procedure that could also influence e.g. a process or the purity of a fluid (e.g., adding a corrosion inhibitor to a clean petrochemical fluid). The implementations generally encompass the use of the magnetic traps in several cases and parts of the plant, e.g. to protect part of the plant from spreading of corrosion products that can cause e.g. alterations to the petrochemical process. The implementations can incorporate a variety of devices adapted for a number of objectives, rather than just particles trapping.

Some implementations can solve a problem of, for example, of increasing delta pressure observed across synthesis reactors. The pressure buildup can be due to iron oxidation products such as magnetite (Fe₃O₄) and goethite (FeOOH) circulating in the plant. Some implementations can also solve a problem of, for example, accumulation of oxidation/corrosion debris on filters or contamination of a fluid made of synthesis products, or contamination of a catalyst bed. In some cases, magnetite (Fe₃O₄) can be predominant. Indeed, corrosion/scale is often found in pipelines and pumps and if captured, can help improving maintenance and improving integrity of the assets.

Implementations can limit the spread of corrosion products resulting from, for example, wet corrosion. The implementations may effectively limit the spread of particles to effective prevent the corrosion products from passing through to the reactors.

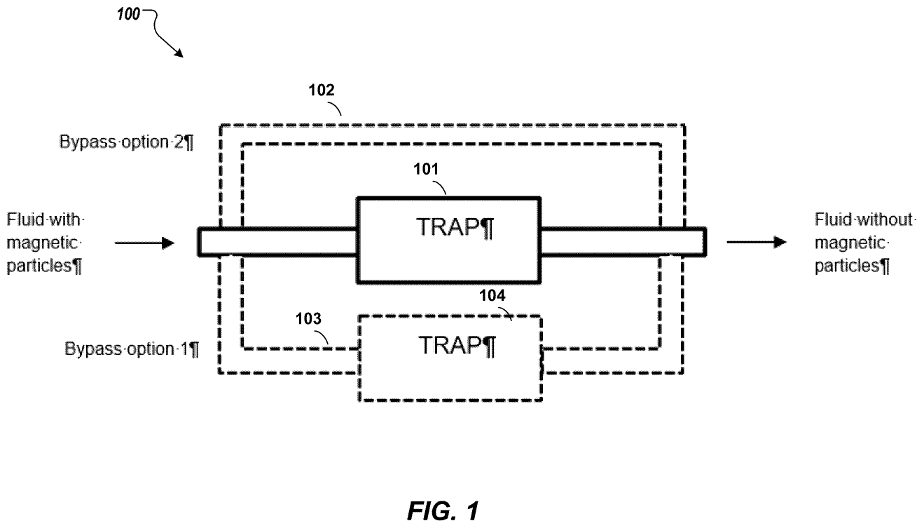

Referring to FIG. 1 illustrating a diagram 100 of examples of a trap system, a magnetic trap can be positioned online in a pipe to locally stop the magnetic particles according to some implementations. As illustrated, a blind system can handle incoming fluid (e.g., hydrocarbon fluid) with magnetic particles using trap 101 to generate fluid without magnetic particles. The blind system can include a bypass with an extra trap. In bypass option 2, a bypass channel 102 can be installed in the system to allow for inspection and cleaning of trap 101 when, for example, the quantity of accumulated particles reaches a critical threshold. Suitable valves positioned on or near the input and output ports of trap 101 or on the tube joint can allow the flux to be diverted for inspection, cleaning, maintenance. Each bypass mode can involve one or more valves. In bypass option 1, a bypass channel 103 with an extra trap 104 can be used to continue protecting the system while trap 101 is inactivated for inspection and maintenance. Suitable flanges can be installed on the input and output ports of traps 101 and 104 to facilitate installation and removal.

In some cases, traps 101 and 104 can be more suitably installed before the plant for protection from the magnetic particles. In some cases, an object or feature, for example, a reactor bed, may be set up for protection. As illustrated, traps 101 and 104 can prevent an increase in pressure drop over the reactor bed or beds in a multi-reactor configuration. In one particular example, multiple traps can be installed in series to improve the performance of the system, especially when large quantities of magnetic powder are present in the fluid. In these examples, each trap can house magnetic elements that include permanent magnets or electromagnets. The electromagnets can be independently controlled and operated.

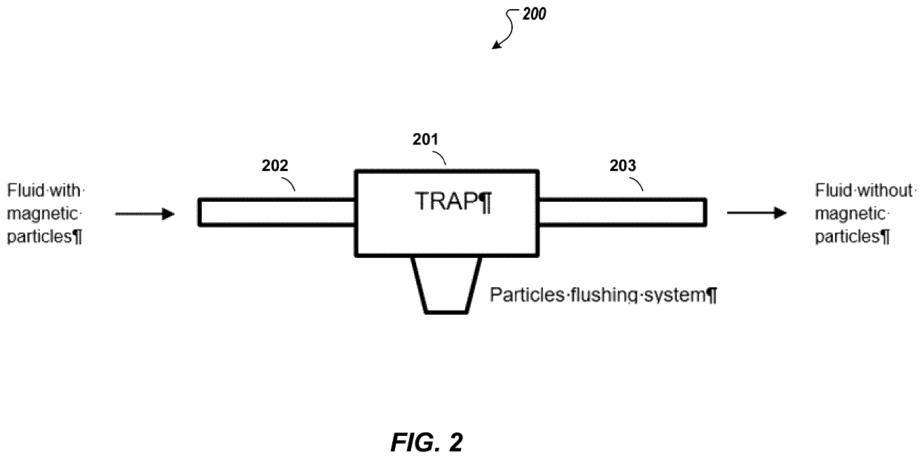

FIG. 2 shows a diagram 200 of an example of a trap system with a flushing sub-system. As illustrated, fluid (e.g., hydrocarbon) with magnetic particles entering the trap system at channel 202 can flow through trap 201 to generate fluid without magnetic particles at channel 203. A bypass can be installed also in this case. Trap 201 is equipped with a flushing system for flushing trapped particles out of the system to limit the need for cleaning inspection. Trap 201 contains magnetic elements, which can be positioned in the flow flux (e.g., in direct contact with flow flux or isolated by shielding). The magnetic elements can also be positioned outside the flow flux (e.g. on the exterior of a pipe in which the particles are present) to stop the magnetic particles. The insulation of the magnetic elements from the flow flux can be necessary when a compatibility between the magnetic elements and the fluid favors the insulation or separation.

The insulation of the magnetic parts and, in general, of the magnetic trap from the rest of the piping can be advantageous when part of the piping in the system can be magnetizable, and a local capture is preferred. In some implementations, many parts of the processing plant can be magnetized to mitigate the problem and stop the magnetic particles from spreading.

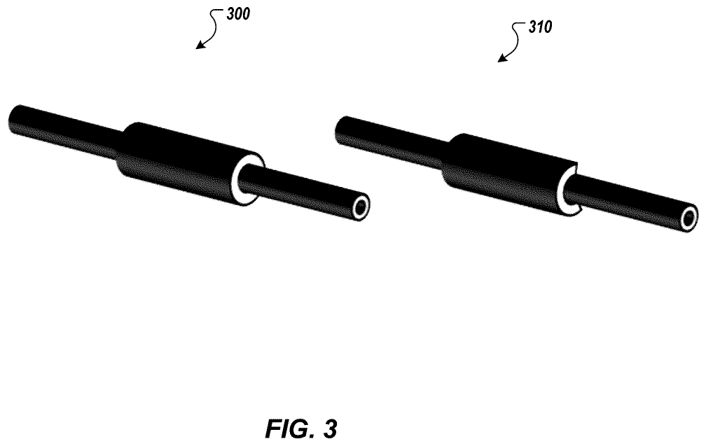

FIG. 3 shows examples of pass-through magnetic traps 300 and 310 used in configurations of FIGS. 1-2. A permanent magnet or an electromagnet can be positioned outside a pipe to cover the full circumference, as illustrated in magnetic trap 300, or an arc of the full circumference, as illustrated in magnetic trap 310. For faster mounting and unmounting, the magnet can be formed by two or more parts attachable, for example, using proper fasteners such as straps of band. To remove the accumulated particles, the part of pipe where the particles accumulated can be sacrificed or replaced. For example, suitable flanges can be used to ease the removal/replacement of the pipe section to be sacrificed. In some cases, after removing the magnet or the magnetic field from the pipe, the magnetic particles can be extracted (e.g., by blowing and suction actions).

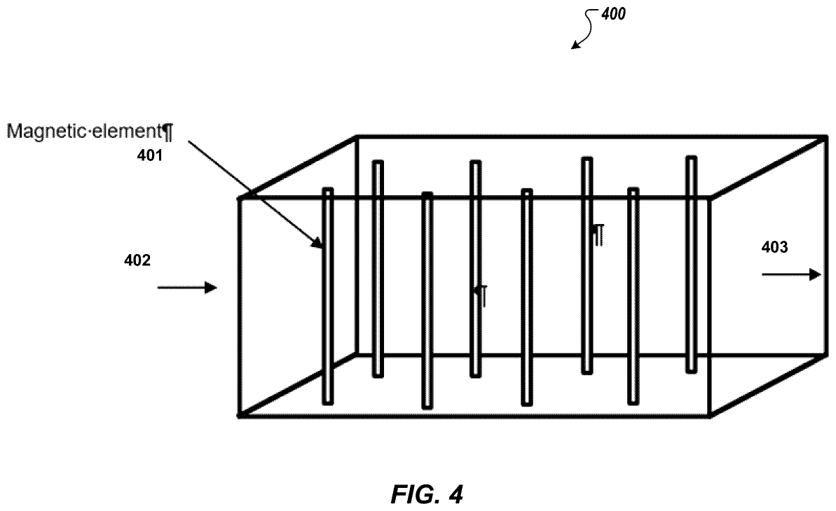

Implementations can incorporate more complex traps and FIG. 4 shows one such example in diagram 400. Here, the trap system includes an array of magnetic elements 401 between an entry port 402 and an exit port 403. The magnetic elements 401 may contain, for example, up to thousands of magnetic elements that are either permanent magnet or electromagnets. The elements can be positioned in a single direction, or in a combination of directions (including vertical, horizontal or diagonal directions) to increase the possible capture area.

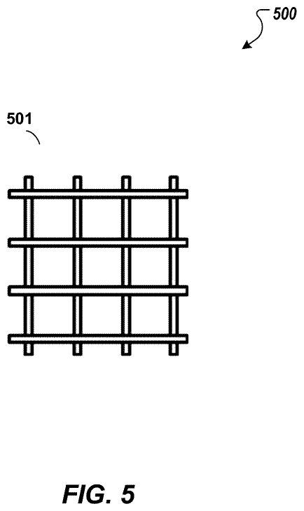

FIG. 5 shows diagram 500 illustrating an example of a trap system with a magnetic grid 501. As illustrated, magnetic grid 501 is configured as a grid, instead of using single separated elements. Multiple magnetic grids 501 can be employed in the trap system of FIGS. 1-2. Magnetic grids with different orientation or different hole patterns (e.g., space enclosed by neighboring grids) can be deployed inside the trap system of FIGS. 1-2 to increase the cross area of capture when fluid flows in the pipe. In addition to square holes (created by horizontal and vertical grid bars), implementations may also include holes in other shapes, for example, a rhombohedral shape.

The cross sections of the trap system can be polygonal or ellipsoidal to accommodate the intake flow of fluid containing magnetic particles and the exit flow of processed fluid without magnetic particles.

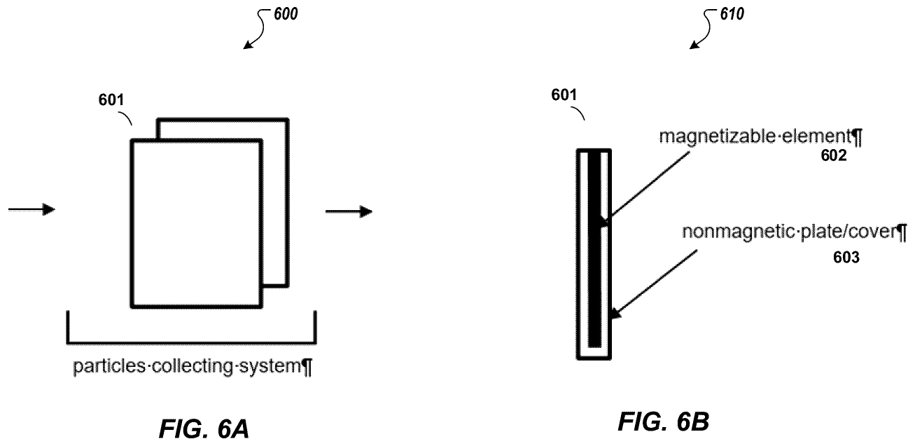

FIGS. 6A to 6B show an example of a trap system with magnetizable plates. Diagram 600 shows magnetizable plates 601 installed on a trap system with particle collection capabilities. Plates can be continuous or have holes e.g. to change the pattern of the magnetic field and/or reduce the weight. Diagram 610 shows a side view of a magnetizable plate 601 with a magnetizable element 602 and a nonmagnetic cover 603. When nonmagnetic cover 603 containing a non-permanently magnetizable element 602 is employed, the trap system can be cleaned by, for example, de-activating the magnetizable element 602. In more detail, the magnetization of the plates 601 activates the trap and the plates 601 attract the magnetic particles towards the non-magnetic surface of nonmagnetic cover 603. When the magnetic field is gone by virtue of de-activating the magnetizable element 602, the magnetic particles can fall by gravity in the illustrated collection system where such particles can be recovered and subsequently removed. Multiple plates can be placed in parallel to handle larger fluxes of flow containing magnetic particles.

The trap system can include an entrance port and an exit port for handling the intake and the exit of fluid flux. The ports can be located on the same side or on different sides of the trap. In some implementations, multiple ports can be added to allow for multiple input and/or multiple outputs of the fluid.

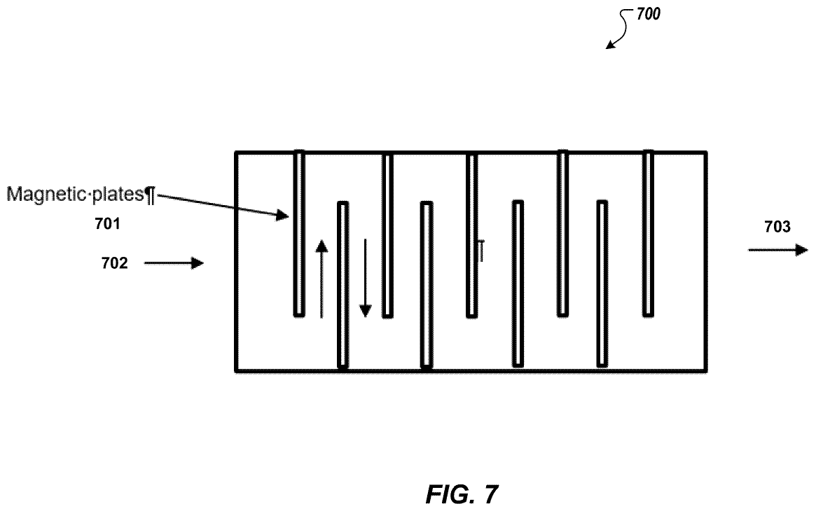

The flow path of the fluid in the trap system can be kept constant or variable. FIG. 7 shows an example of a trap system in which fluid is forced to change direction. Diagram 700 illustrate a side view of a trap in which the fluid changes flow direction by virtue of the configuration of magnetic plates 701. As illustrated, the magnetic plates 701 (e.g., magnetizable with nonmagnetic surface as illustrated in FIGS. 6A-6B) are spaced to form partial blockage so that the flow path of fluid takes turns to traverse the surface area of each magnetic plate 701. The spacing of the magnetic plates 701 can be variable, for example, to allow for more space at the entrance 702 where the particles may tend to accumulate more than when the flow reaches exit 703.

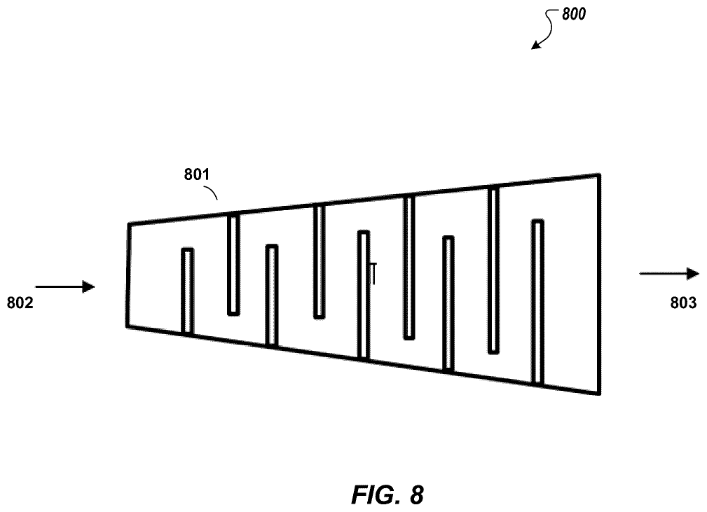

The entry and exit port and/or the shape of the trap system can be designed to change the velocity and direction of the fluid flowing inside. FIG. 8 shows an example of a trap system in a tapered configuration. As illustrated, the entry port 802 has a smaller profile than that of the exit port 803. Magnetic plates 801 spaced inside the trap system tend to have larger dimensions when situated closer to the exit port 803. Such configuration can induce a slow-down of the fluid to allow for longer dwell time for capturing magnetic particles. Indeed, decelerating the fluid would allow for more magnetic particles to be captured in the same amount of time. The ability to decelerate can also allow for changing the characteristics of the fluid while magnetic particles are being captured. Further, when the entry port and exit port are reversed in direction, the tapered configuration can be used to accelerate the flow therein. Using a combination of the tapered configurations (e.g., in serial arrangements), both acceleration and deceleration can be achieved.

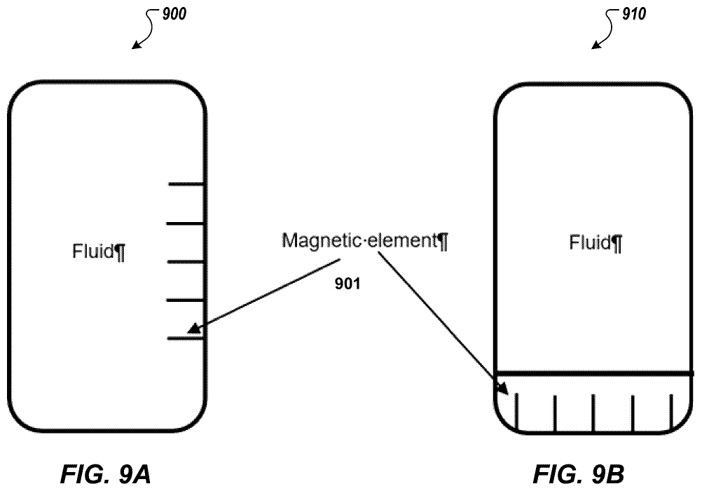

The magnetic elements can be installed inside or outside of the relevant portion of the plant. FIGS. 9A and 9B show examples of a trap system with magnetic elements installed on the side or the bottom of a reactor or a vessel. Diagram 900 shows magnetic elements 901 installed on the side of a reactor or a vessel. In some cases, multiple sides of the vessel can be transformed into trap using this configuration. Diagram 910 shows magnetic elements 901 installed on the bottom of a reactor or a vessel. The configurations can also be placed upside down. In these configurations, the trap can span either the full area of the vessel/reactor or a portion thereof.

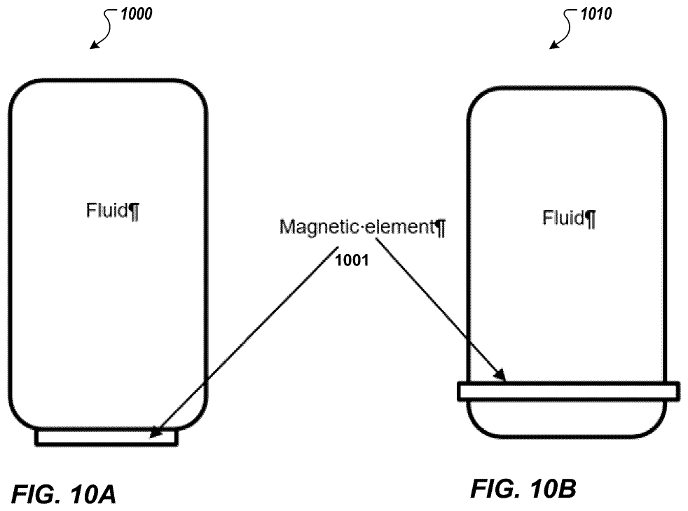

FIGS. 10A and 10B show examples of a trap system with magnetic elements installed on the exterior. Diagram 1000 illustrates magnetic elements 1001 installed on the exterior bottom of structure such as a pipe, a reactor, or a vessel. Diagram 1010 illustrates magnetic elements 1001 installed on the exterior side or circumference of such a structure. In both diagrams, the configurations can be placed upside down.

Implementations may leverage a pump with a magnetic strainer to limit the spread of the magnetic corrosion products to part of the plant and to avoid contamination. In the same manner, magnetic filters e.g. made of magnetic sponge or magnetic mesh can be used to block the circulation of the particles inside the plant. Implementations may incorporate a magnetic strainer to protect the corresponding pump from magnetic iron oxides. Additionally or alternatively, a magnetic strainer and a magnetic filter can jointly limit the spread of these magnetic oxides to spare a critical portion of a plant or to stop other magnetic corrosion products such as e.g. sulfides from reaching the critical portion where corrosion can cause issues.

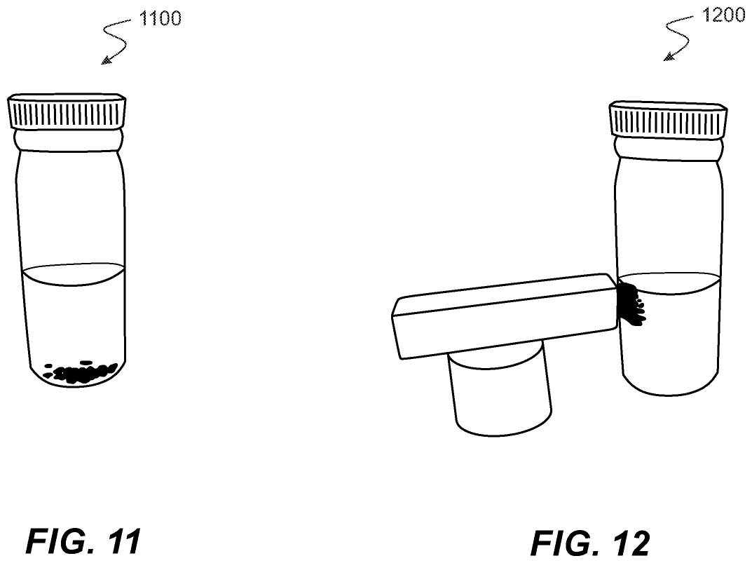

FIGS. 11 and 12 show photos of the fluid before and after using a magnetic trap (permanent magnet) to capture Magnetite. Example 1100 shows a photo of n-pentane with dispersed powder while example 1200 shows a photo of n-pentane with magnetic trap positioned outside. The residual particles dispersed in the liquid are evident in FIG. 12.

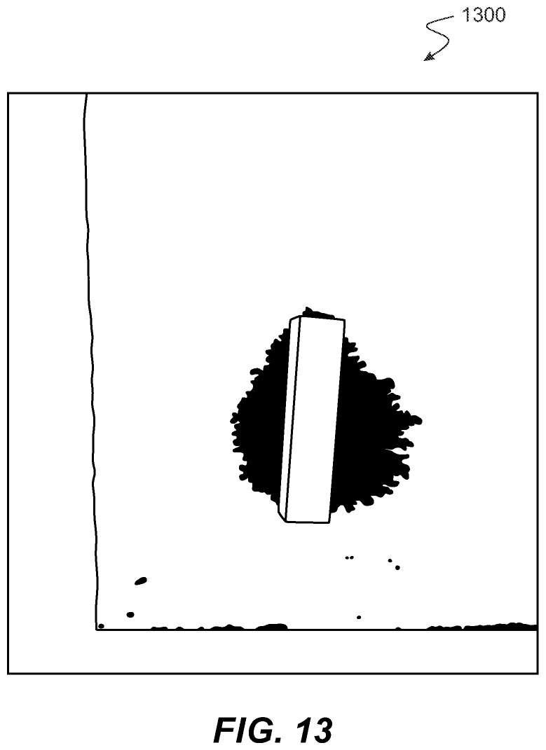

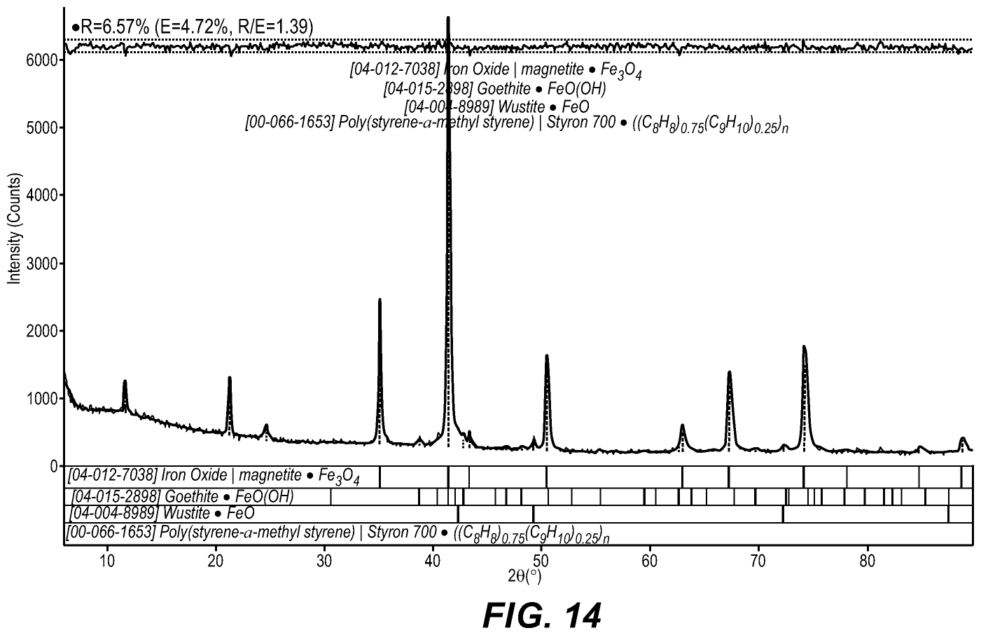

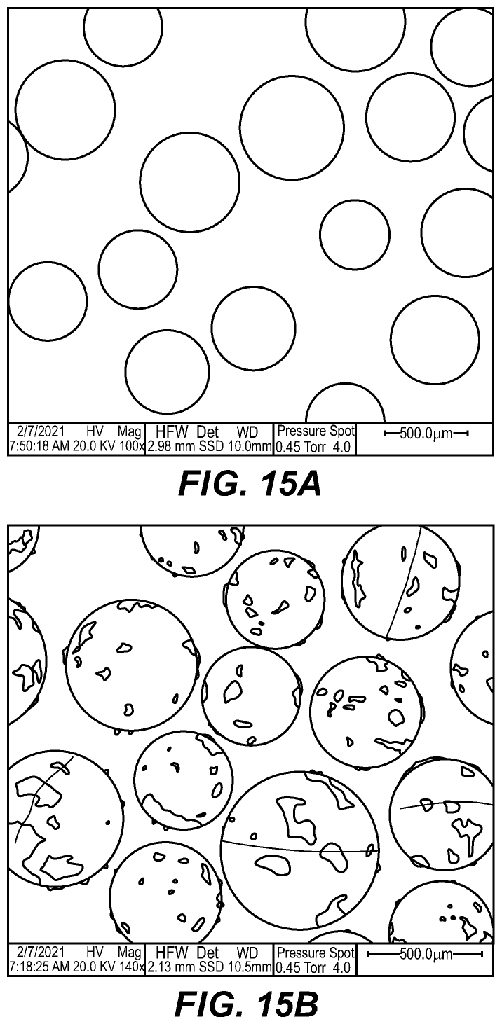

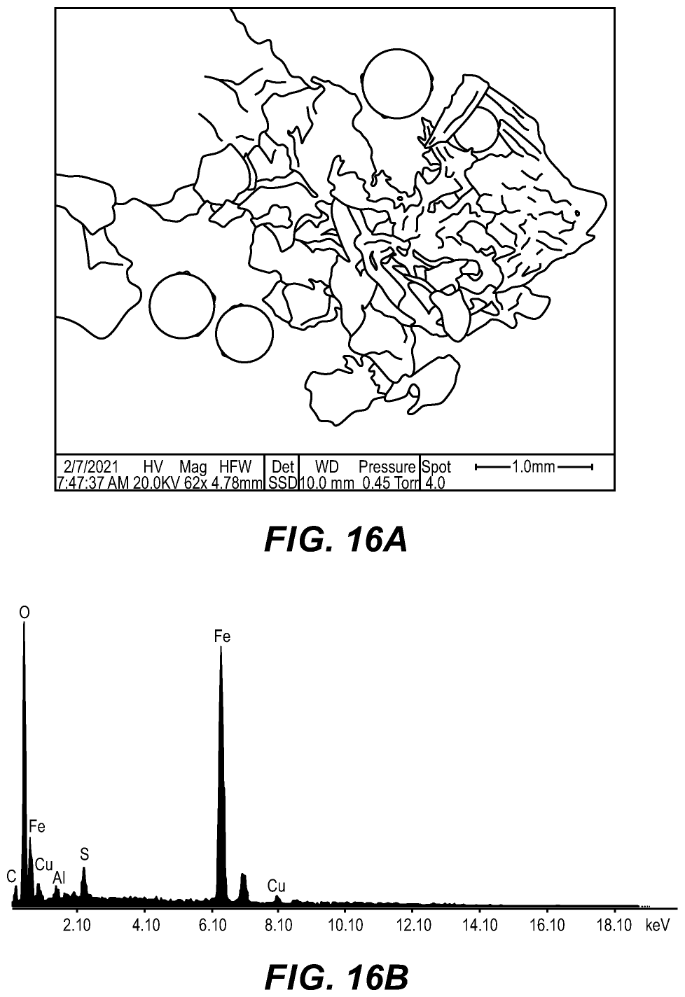

FIG. 13 shows an example of corrosion product attracted by a trap system. Example 1300 is a photo showing some of the corrosion material collected from a trap system disclosed above. The diffraction pattern of the powder from the corrosion products, evidencing the composition of the corrosion products, is shown in FIG. 14. The environmental scanning electron microscopy (ESEM) images of FIGS. 15A and 15B provide a comparison between the fresh catalyst (FIG. 15A) and some skimmed catalyst (FIG. 15B) showing the contamination from the corrosion products. FIG. 16A shows the ESEM image of some of the collected corrosion products while FIG. 16B shows the corresponding energy dispersive X-ray spectroscopy (EDXS) image that confirms the presence of iron oxides.

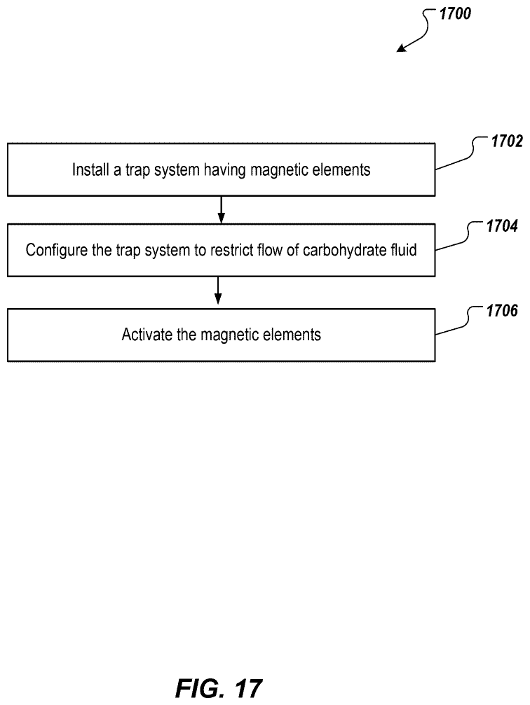

FIG. 17 is a flow chart 1700 illustrating an example of a process for trapping corrosion products in a plant according to some implementations. The process may start with installing a trap system at the plant where a hydrocarbon fluid is being processed (1702). The trap system may include one or more magnetic elements, at least one entry port, and at least one exit port. Examples of the trap system can be found at FIGS. 1-2 and 4.

The process may then configure the trap system such that the hydrocarbon fluid flows in a prescribed pattern through the trap system (1704). For example, the magnetic elements may be arranged to form a partial blockage of the hydrocarbon fluid flowing in the trap system. Examples for arranging the magnetic elements can be found in FIGS. 7-8. In these examples, the trap system can be configured such that the at least one entry port and at least one exit port are sized and shaped for the hydrocarbon fluid flowing in the trap system to accelerate between the at least one entry port and at least one exit port. Alternatively or additionally, the trap system can be configured such that the at least one entry port and at least one exit port are sized and shaped for the hydrocarbon fluid flowing in the trap system to decelerate between the at least one entry port and at least one exit port.

The process may then activate the one or more magnetic elements of the trap system (1706). The activation can refer to an action of switching on the one or more magnetic elements to emanate a magnetic field. The activation may also refer to an action of repositioning the one or more magnetic elements (e.g., bringing a permanent magnet into proximity, reorienting a permanent magnet). In response to this activation, the corrosion products in the hydrocarbon fluid are retained by the one or more magnetic elements and limited to portions of the plant while the hydrocarbon fluid flows from the at least one entry port to the at least one exit port.

The process may further include: installing at least one bypass channel for the hydrocarbon fluid flowing in the trap system. The at least one bypass channel may be configured such that when the one or more magnetic elements are de-activated, the hydrocarbon fluid flows through the at least one bypass channel. The at least one bypass channel may be configured to include at least one additional magnetic element for the hydrocarbon fluid flowing through the at least one bypass channel, wherein the at least one additional magnetic element is different from the one or more magnetic elements.

The process may additionally include: configuring a particle collection sub-system such that when the one or more magnetic elements are de-activated, the corrosion products retained by the one or more magnetic elements are extracted from the trap system. The process may further include: installing a non-magnetic cover for each of the one or more magnetic elements. The one or more magnetic elements may be configured as a grid. The one or more magnetic elements may be configured on an exterior of a portion of the trap system.

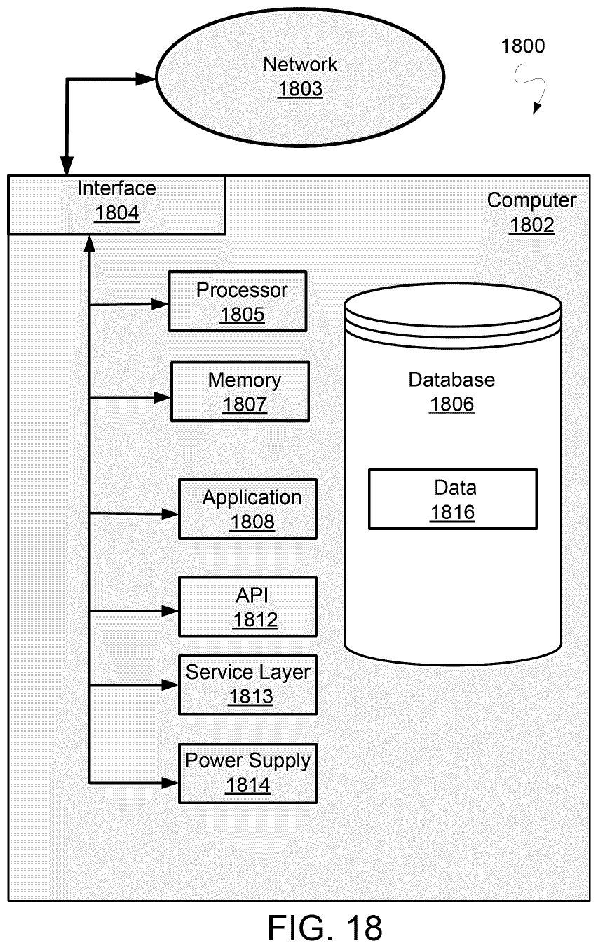

Some implementations can be executed or automated by a computer system incorporating one or more computer processors. FIG. 18 is a block diagram illustrating an example of a computer system 1800 used to provide computational functionalities associated with described algorithms, methods, functions, processes, flows, and procedures, according to an implementation of the present disclosure. The illustrated computer 1802 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 1802 can comprise a computer that includes an input device, such as a keypad, keyboard, touch screen, another input device, or a combination of input devices that can accept user information, and an output device that conveys information associated with the operation of the computer 1802, including digital data, visual, audio, another type of information, or a combination of types of information, on a graphical-type user interface (UI) (or GUI) or other UI.

The computer 1802 can serve in a role in a computer system as a client, network component, a server, a database or another persistency, another role, or a combination of roles for performing the subject matter described in the present disclosure. The illustrated computer 1802 is communicably coupled with a network 1803. In some implementations, one or more components of the computer 1802 can be configured to operate within an environment, including cloud-computing-based, local, global, another environment, or a combination of environments.

The computer 1802 is an electronic computing device operable to receive, transmit, process, store, or manage data and information associated with the described subject matter. According to some implementations, the computer 1802 can also include or be communicably coupled with a server, including an application server, e-mail server, web server, caching server, streaming data server, another server, or a combination of servers.

The computer 1802 can receive requests over network 1803 (for example, from a client software application executing on another computer 1802) and respond to the received requests by processing the received requests using a software application or a combination of software applications. In addition, requests can also be sent to the computer 1802 from internal users, external or third-parties, or other entities, individuals, systems, or computers.

Each of the components of the computer 1802 can communicate using a system bus 1803. In some implementations, any or all of the components of the computer 1802, including hardware, software, or a combination of hardware and software, can interface over the system bus 1803 using an application programming interface (API) 1812, a service layer 1813, or a combination of the API 1812 and service layer 1813. The API 1812 can include specifications for routines, data structures, and object classes. The API 1812 can be either computer-language independent or dependent and refer to a complete interface, a single function, or even a set of APIs. The service layer 1813 provides software services to the computer 1802 or other components (whether illustrated or not) that are communicably coupled to the computer 1802. The functionality of the computer 1802 can be accessible for all service consumers using this service layer. Software services, such as those provided by the service layer 1813, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 1802, alternative implementations can illustrate the API 1812 or the service layer 1813 as stand-alone components in relation to other components of the computer 1802 or other components (whether illustrated or not) that are communicably coupled to the computer 1802. Moreover, any or all parts of the API 1812 or the service layer 1813 can be implemented as a child or a sub-module of another software module, enterprise application, or hardware module without departing from the scope of the present disclosure.

The computer 1802 includes an interface 1804. Although illustrated as a single interface 1804 in FIG. 18, two or more interfaces 1804 can be used according to particular needs, desires, or particular implementations of the computer 1802. The interface 1804 is used by the computer 1802 for communicating with another computing system (whether illustrated or not) that is communicatively linked to the network 1803 in a distributed environment. Generally, the interface 1804 is operable to communicate with the network 1803 and comprises logic encoded in software, hardware, or a combination of software and hardware. More specifically, the interface 1804 can comprise software supporting one or more communication protocols associated with communications such that the network 1803 or interface's hardware is operable to communicate physical signals within and outside of the illustrated computer 1802.

The computer 1802 includes a processor 1805. Although illustrated as a single processor 1805 in FIG. 18, two or more processors can be used according to particular needs, desires, or particular implementations of the computer 1802. Generally, the processor 1805 executes instructions and manipulates data to perform the operations of the computer 1802 and any algorithms, methods, functions, processes, flows, and procedures as described in the present disclosure.

The computer 1802 also includes a database 1806 that can hold data for the computer 1802, another component communicatively linked to the network 1803 (whether illustrated or not), or a combination of the computer 1802 and another component. For example, database 1806 can be an in-memory, conventional, or another type of database storing data consistent with the present disclosure. In some implementations, database 1806 can be a combination of two or more different database types (for example, a hybrid in-memory and conventional database) according to particular needs, desires, or particular implementations of the computer 1802 and the described functionality. Although illustrated as a single database 1806 in FIG. 18, two or more databases of similar or differing types can be used according to particular needs, desires, or particular implementations of the computer 1802 and the described functionality. While database 1806 is illustrated as an integral component of the computer 1802, in alternative implementations, database 1806 can be external to the computer 1802. As illustrated, the database 1806 holds the previously described data 1816 including, for example, data encoding activation status and history of the magnetic elements, measurements taken from the hydrocarbon samples in the trap system and the plant.

The computer 1802 also includes a memory 1807 that can hold data for the computer 1802, another component or components communicatively linked to the network 1803 (whether illustrated or not), or a combination of the computer 1802 and another component. Memory 1807 can store any data consistent with the present disclosure. In some implementations, memory 1807 can be a combination of two or more different types of memory (for example, a combination of semiconductor and magnetic storage) according to particular needs, desires, or particular implementations of the computer 1802 and the described functionality. Although illustrated as a single memory 1807 in FIG. 18, two or more memories 1807 or similar or differing types can be used according to particular needs, desires, or particular implementations of the computer 1802 and the described functionality. While memory 1807 is illustrated as an integral component of the computer 1802, in alternative implementations, memory 1807 can be external to the computer 1802.

The application 1808 is an algorithmic software engine providing functionality according to particular needs, desires, or particular implementations of the computer 1802, particularly with respect to functionality described in the present disclosure. For example, application 1808 can serve as one or more components, modules, or applications. Further, although illustrated as a single application 1808, the application 1808 can be implemented as multiple applications 1808 on the computer 1802. In addition, although illustrated as integral to the computer 1802, in alternative implementations, the application 1808 can be external to the computer 1802.

The computer 1802 can also include a power supply 1814. The power supply 1814 can include a rechargeable or non-rechargeable battery that can be configured to be either user- or non-user-replaceable. In some implementations, the power supply 1814 can include power-conversion or management circuits (including recharging, standby, or another power management functionality). In some implementations, the power-supply 1814 can include a power plug to allow the computer 1802 to be plugged into a wall socket or another power source to, for example, power the computer 1802 or recharge a rechargeable battery.

There can be any number of computers 1802 associated with, or external to, a computer system containing computer 1802, each computer 1802 communicating over network 1803. Further, the term “client,” “user,” or other appropriate terminology can be used interchangeably, as appropriate, without departing from the scope of the present disclosure. Moreover, the present disclosure contemplates that many users can use one computer 1802, or that one user can use multiple computers 1802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method for trapping corrosion products in a plant, the method comprising.
installing, at the plant where a fluid is being processed, a trap system having one or more magnetic elements, at least one entry port, and at least one exit port;
configuring the trap system such that the fluid flows in a prescribed pattern through the trap system; and
activating the one or more magnetic elements of the trap system such that the corrosion products in the fluid are retained by the one or more magnetic elements and limited to portions of the plant while the fluid flows from the at least one entry port to the at least one exit port.

2. The method of claim 1, wherein configuring the trap system comprises:
arranging the magnetic elements that form a partial blockage of the fluid flowing in the trap system.

3. The method of claim 1, wherein configuring the trap system comprises:
configuring the trap system such that the at least one entry port and at least one exit port are sized and shaped for the fluid flowing in the trap system to accelerate between the at least one entry port and at least one exit port.

4. The method of claim 1, wherein configuring the trap system comprises:
configuring the trap system such that the at least one entry port and at least one exit port are sized and shaped for the fluid flowing in the trap system to decelerate between the at least one entry port and at least one exit port.

5. The method of claim 1, wherein configuring the trap system comprises:
installing at least one bypass channel for the fluid flowing in the trap system.

6. The method of claim 5, further comprising:
configuring the at least one bypass channel such that when the one or more magnetic elements are de-activated, the fluid flows through the at least one bypass channel.

7. The method of claim 5, further comprising:
configuring the at least one bypass channel to include at least one magnetic element for the fluid flowing through the at least one bypass channel, wherein the at least one magnetic element is different from the one or more magnetic elements.

8. The method of claim 1, further comprising:
configuring a particle collection sub-system such that when the one or more magnetic elements are de-activated, the corrosion products retained by the one or more magnetic elements are extracted from the trap system.

9. The method of claim 1, further comprising:
installing a non-magnetic cover for each of the one or more magnetic elements.

10. The method of claim 1, further comprising:
configuring the one or more magnetic elements as a grid.

11. The method of claim 1, further comprising:
configuring the one or more magnetic elements on an exterior of a portion of the trap system.

12. A trap system for trapping corrosion products in a plant where a fluid is being processed, the trap system comprising:
one or more magnetic elements;
at least one entry port; and
at least one exit port,
wherein the fluid flows in a prescribed pattern through the trap system, and
wherein when the one or more magnetic elements are activated, the corrosion products in the fluid are retained by the one or more magnetic elements and limited to portions of the plant while the fluid flows from the at least one entry port to the at least one exit port.

13. The trap system of claim 12, wherein the magnetic elements are configured to form a partial blockage of the fluid flowing in the trap system.

14. The trap system of claim 12, wherein the at least one entry port and at least one exit port are sized and shaped for the fluid flowing in the trap system to accelerate between the at least one entry port and at least one exit port.

15. The trap system of claim 12, wherein the at least one entry port and at least one exit port are sized and shaped for the fluid flowing in the trap system to decelerate between the at least one entry port and at least one exit port.

16. The trap system of claim 12, further comprising:
at least one bypass channel for the fluid flowing in the trap system such that when the one or more magnetic elements are de-activated, the fluid flows through the at least one bypass channel.

17. The trap system of claim 16, wherein the at least one bypass channel comprises at least one magnetic element for the fluid flowing through the at least one bypass channel, and
wherein the at least one magnetic element is different from the one or more magnetic elements.

18. The trap system of claim 12, further comprising:
a particle collection sub-system such that when the one or more magnetic elements are de-activated, the corrosion products retained by the one or more magnetic elements are extracted from the trap system.

19. The trap system of claim 12, further comprising:
a non-magnetic cover for each of the one or more magnetic elements.

20. The trap system of claim 12, wherein the one or more magnetic elements are configured as a grid.
